(19) United States
(12) Patent Application Publication
(10) Pub. No.: US 2010/0285911 A1
(43) Pub. Date: Nov. 11, 2010

(54) AUTOMATIC BELT TENSIONING DEVICE

(76) Inventor: Richard DOWNES, Bucksport, ME (US)

Correspondence Address: ANTHONY D. PELLEGRINI RUDMAN & WINCHELL, LLC, 84 HARLOW STREET, P.O. BOX 1401, BANGOR, ME, 04402-1401, US

(21) Appl. No.: 12/436,275

(22) Filed: May 6, 2009

(51) Int. Cl. F16H 7/08

(52) U.S. Cl. 474/110

(57) ABSTRACT

An automatic belt tensioning device for use with a belt-driven transmission system, the belt-driven transmission system being designed to transmit power from a power generating device to work performing machinery by use of one or more flexible, continuous loop belts, with the one or more belts mechanically linking two or more rotatable shafts, each shaft having one or more sheaves capable of engaging with the belts, whereby at least one shaft is integrated with the power generating device and at least one shaft is integrated with the work performing machinery, said automatic belt tensioning device having an air spring interposed between the power generating device and the work performing machinery capable of moving the power generating device away from the work performing machinery during operation, such movement dynamically increasing the distance between the power generating device and the work performing motor such that appropriate tension is maintained in the one or more belts notwithstanding any slackening of the one or more belts during operation.

### BACKGROUND OF THE INVENTION

1. Field of Invention

The invention relates generally to belt-driven transmission systems for powering industrial machinery. Specifically, the invention relates to an automatic belt tensioning device for use with belt-driven transmission systems which maintains the proper tension of the belts during operation of the system without the need for stopping operation to retension the belts.

2. Description of Prior Art

Belt-driven transmission systems use one or more flexible, continuous loop belts to mechanically link two or more rotating shafts to transmit power, with at least one of the shafts being associated with a power source and at least one other shaft associated with the work-providing machinery. For example, large paper presses often use one or more motors to rotate large rollers, with the power transmitted from the motors to the rollers by belt-driven transmission systems.

Belts are typically made of natural or synthetic rubber material, polyester, or flexible reinforced plastic. They are looped over pulleys known as sheaves which are attached to the rotating shafts. Proper tension must be maintained in the belt to allow it to efficiently rotate the sheaves; a belt which is over-tensioned may place excessive strain on the sheaves, shafts, and bearings, causing accelerated wear on the machinery as well as requiring more energy usage, and a belt which is under-tensioned may slip during operation, leading to power transmission inefficiencies and damage to the belts. Where a multiple belt system is employed (i.e., multiple belts are used to link the same shafts), any one belt may be under-tensioned relative to the other belts, disrupting operation of the system (where a single belt may be under-tensioned but still remain within an acceptable range for operation, if multiple belts have different tensions the least tensioned belts will fail to provide power to the system, overloading the other belts).

The ideal tension of a belt is the least amount of tension that avoids any slippage. Belts are typically properly tensioned upon installation. However, due to the flexible nature of belts, they tend to stretch over time, and even an infinitesimal amount of elongation can lead to unacceptable under-tensioning.

A belt in a belt-driven transmission system typically is retensioned when the belt-driven transmission system is offline (that is, the belt is not running). This leads to inefficient use of the machinery. To minimize downtime, new belts are often over-tensioned by as much as 30%, to account for future stretching during use. However, this places an initial strain on the machinery and accelerates wear and tear, and is energy inefficient. Moreover, even with the initial over-tensioning, the belts will eventually stretch enough that retensioning is required, with the associated downtime.

The retensioning of belts is typically performed by manipulating the distance between the centers of the shaft axels. Increasing the distance increases the tension on the belt, and decreasing the distance decreases the tension. This distance is manipulated by moving the motor in relation to the machinery. A motor is typically mounted on a track so that its relative position to the machinery can be easily changed, thereby achieving the correct distance between the centers of the shaft axels. To accomplish this task, the motor is unlocked from the track and repositioned forward or rearward as desired. Once the appropriate distance between the motor and the machinery is obtained the motor is locked down onto the track, preventing further movement until such time as retensioning must again be performed.

Tension is often measured using a mechanical tool which initiates a flex in the stationary belt; the amount of downward pressure, measured in pounds, necessary to introduce a displacement of one vertical inch in the belt is a typical measure of tension. The distance between the centers of the shaft axels is adjusted until the desired amount of downward pressure (say, forty pounds) achieves the correct vertical displacement. The distance between the centers of the shaft axels is then fixed by locking the motor to the track. The tension of a stationary belt may also be measured by electronic devices using sonic sensors. However, the actual tensioning of the belt is performed in the same manner.

From the foregoing, it is evident that automatic retensioning of belts in a belt-driven transmission system is highly desirable. The ability to accurately retension a belt during operation not only avoids the downtime typically associated with retensioning but also allows for more precise initial tensioning to avoid excess strain on the machinery and optimal energy usage.

One method of retensioning a belt during operation is to apply pressure to the belt by means of a moveable arm having a pulley. See, e.g., U.S. Pat. No. 4,473,362 (Sep. 25, 1984), to Thomey, et al., for “Belt tensioner with variably proportional damping”. Such an arm may be biased by a spring or by hydraulics so that the pulley is pressed against the moving belt, with the tension of the belt offsetting the tension of the moveable arm. The combined tensions of the belt and arm create the desired overall tension of the system. As the tension of the belt lessens due to stretching, the movable arm is further biased onto the belt by the spring or by a hydraulic cylinder, thereby retaining the overall tension of the system at the desired tension. Thus, the system remains at the optimum tension without having to stop operation to retension the belt. An obvious disadvantage to such a mechanism is the need to place an additional pulley against the belt, potentially disrupting the smooth rotation of the belt, decreasing the efficiency of the power transmission, and increasing wear on the belt.

Another method of automatically retensioning a belt during operation is by the use of one or more electronically controlled hydraulic tensioning cylinders used to move the shaft axels away from or towards each other. See, e.g., U.S. Pat. No. 5,641,058 (Jun. 24, 1997), Merten, et al., “Method and a device for tensioning endless drive belts”. Sensors determine whether the belt is over-tensioned or under-tensioned, and then the hydraulic cylinders are used to push or pull the shaft axels away from or towards each other. While this method appears to address the need for dynamic automatic belt tensioning, it has the disadvantage of complexity, whereby sophisticated electronics and sensors are needed to constantly monitor the tension of the belt and to effect the proper repositioning of the shaft axels.

There is thus described a need for a simple device to automatically retain the one or more belts of a belt-driven transmission system at its preferred tension during operation without adding any extraneous contact on the belt, thus achieving the benefits of automatic retensioning without compromising the performance of the belts or the belt-driven transmission system.

It is therefore an object of the invention to provide an automatic belt tensioning device which automatically retains the one or more belts of a belt-driven transmission system at its preferred tension during operation.

It is a further object of the invention to provide an automatic belt tensioning device which automatically retains the one or more belts of a belt-driven transmission system at its preferred tension without adding extraneous contact on the belts.

It is yet a further object of the invention to provide an automatic belt tensioning device which automatically retains the one or more belts of a belt-driven transmission system at its preferred tension without the need for external sensors to determine the tensions of the belts.

It is yet a further object of the invention to provide an automatic belt tensioning device which automatically retains the one or more belts of a belt-driven transmission system at its preferred tension by use of inflatable air springs.

Other objects of this invention will be apparent to those skilled in the art from the description and claims which follow.

### SUMMARY OF THE INVENTION

The present invention discloses an improved automatic belt tensioning device which automatically retains the one or more belts of a belt-driven transmission system at its preferred tension by use of an inflatable air spring. An air spring will expand when a gas is introduced into its interior. The expansion will continue until the structural capacity of the air spring is met (i.e., it is fully inflated) or until an outside force or forces acting on the air spring exactly offsets the atmospheric pressure of the gas within it, at which point expansion of the air spring ceases. An air spring is designed to expand primarily in a linear dimension.

In the present invention, the air spring is positioned between the power generating device, typically an electric motor, and the work performing machinery. It is oriented such that its linear expansion is along an axis substantially parallel to the straight-line distance between the centers of the shaft axels of the motor and the machinery. The motor is movable in relation to the machinery during operation, such that expansion of the air spring is capable of moving the motor away from the machinery.

Before operation begins, the one or more belts are placed onto their respective sheaves. The motor is positioned an appropriate distance from the machinery to create the desired tension in the one or more belts. The air spring is inflated to the desired pressure, expanding linearly between the motor and the machinery until the gap between the motor and the machinery is completely occupied by the air spring. The air spring is thereafter maintained at a constant pressure. The resiliency of the one or more belts tends to draw the movable motor towards the machinery while the pressure exerted by the air spring tends to force the movable motor and the machinery apart. When the one or more belts are properly tensioned these two opposing forces are in equilibrium.

The one or more belts of the belt-driven transmission system are maintained at the preferred tension by the air spring dynamically increasing the distance between the centers of the shaft axels during operation. As the one or more belts slacken during use, their overall length increases slightly, which would ordinarily result in a corresponding decrease in tension. However, because the air spring expands against this slight lengthening of the one or more belts, slightly increasing the distance between the motor and the machinery, the desired tension of the one or more belts is maintained. The lengthening of the one or more belts and the expansion of the air spring occur simultaneously, so that there is no loss in tension and the opposing forces of the one or more belts and the air spring remain in equilibrium. Thus, during operation of the belt-driven transmission system there is a continuous, imperceptible movement of the motor away from the machinery, with the ever increasing distance between the motor and the machinery maintaining the desired tension in the one or more belts.

Because the air spring is maintained at a constant pressure, it expands against the slackening one or more belts automatically, without the need for sensors or other measurement devices to monitor the tension of the one or more belts. This greatly simplifies the process of maintaining proper tension in the belt-driven transmission system.

The present invention contemplates the use of a pressurization device to maintain the air spring at a constant pressure, such as a standard air compressor. The movement of the motor relative to the machinery can be accomplished by the motor being mounted on wheels, or on a track, or on rails, or the like. The air spring may be in direct contact with the motor and/or the machinery, or it may be indirectly in contact with either or both via intermediate couplers.

Other features and advantages of the present invention are described below.

### DESCRIPTION OF THE DRAWINGS

FIG. 1 is a side view of one embodiment of the present invention employing a horizontal belt-driven transmission system.

FIG. 2 is the same view as depicted in FIG. 1 with the air spring deflated.

FIG. 3 is a top view of the embodiment depicted in FIG. 1 configured as a twin pulley system.

FIG. 4 is a side view of an alternative embodiment of the present invention employing a vertical belt-driven transmission system.

FIG. 5 is a perspective view of one embodiment of the movable carriage.

### DETAILED DESCRIPTION OF THE INVENTION

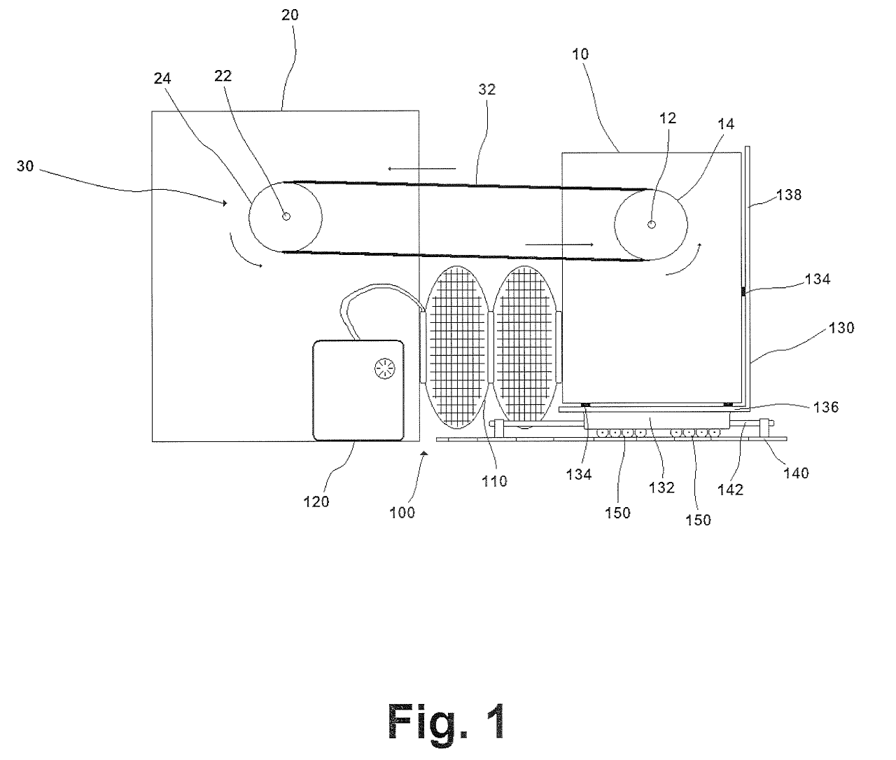

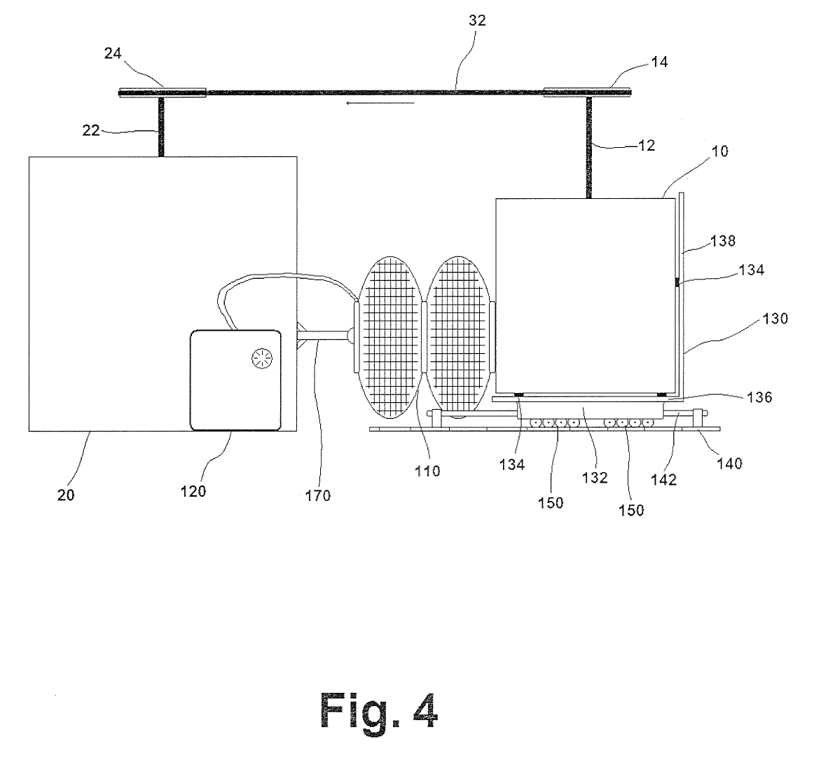

The present invention discloses an automatic belt tensioning device 100 for use with a belt-driven transmission system 30. The belt-driven transmission system 30 is designed to transmit power from a power generating device 10 to work performing machinery 20 by use of one or more flexible, continuous loop belts 32. The one or more belts 32 mechanically link two or more rotatable shafts 12,22, each shaft 12,22 having one or more sheaves 14,24 capable of engaging with the belts 32, whereby at least one shaft 12 is integrated with the power generating device 10 and at least one shaft 22 is integrated with the work performing machinery 20. The rotation of the one or more shafts 12 of the power generating device 10 causes movement of the one or more belts 32, which in turn rotates the one or more shafts 22 of the work performing machinery 20, providing power thereto. See FIG. 1. Systems may be configured with a horizontal belt-driven transmission system 30, whereby the shafts 12, 22 are oriented substantially horizontally and the sheaves 14, 24 lie in a substantially vertical plane, see FIGS. 1, 2, and 3, as well as configured with a vertical belt-driven transmission system 30, whereby the shafts 12, 22 are oriented substantially vertically and the sheaves 14, 24 lie in a substantially horizontal plane, see FIG. 4. Other configurations of the belt-driven transmission system 30 are also contemplated.

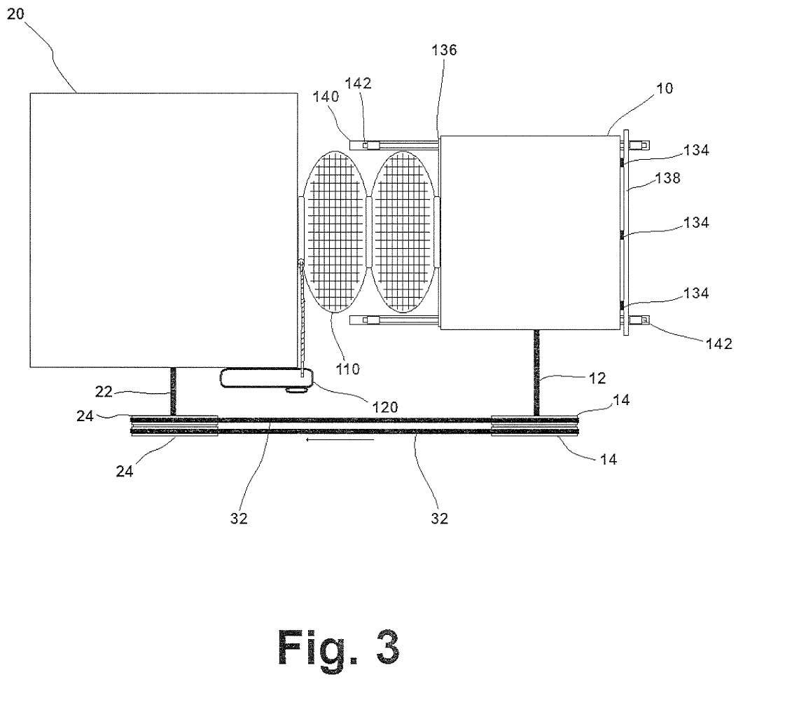

The power generating device 10 is typically an industrial electric motor, such as a NEMA (National Electrical Manufacturers Association) standard motor, having a power output of between 25 and 600 horsepower, though motors with other power ratings also may be used. The power generating device 10 has one or more rotatable shafts 12 extending therefrom, each of which has mounted upon it one or more pulleys known as sheaves 14. The work performing machinery 20 may be any type of industrial machinery requiring rotational movement. For example, paper making machinery comprises large rollers which must be rotated at a high rate of speed. The work performing machinery 20 also has one or more rotatable shafts 22 extending therefrom, each of which has mounted upon it one or more sheaves 24. The one or more rotatable shafts 22 of the work performing machinery 20 are oriented substantially parallel to the one or more rotatable shafts 12 of the power generating device 10. Each of the one or more sheaves 24 of the work performing machinery 20 is paired with a sheave 14 of the power generating device 10, with the sheaves 14, 24 of each pair being substantially coplanar. A belt 32 is engaged upon each pair of sheaves 14, 24. In one embodiment multiple belts 32 may run on a single pair of multi-groove sheaves. See FIG. 3. The one or more belts 32 may be any type of flexible continuous loop belt 32 typically used in industrial applications. A common type of belt 32 is known as a “V-belt”, which has a trapezoidal cross-section shape. The “V” shape of the belt 32 tracks in a mating groove in the sheave, with the result that the belt 32 does not slip off. Other types of belts 32 that may be used in belt-driven transmission systems 30 include flat belts 32 and round belts 32, which have a circular cross-section shape.

In the present invention, the power generating device 10 is in movable relationship with the work performing machinery 20. The movement of the power generating device 10 relative to the work performing machinery 20 is substantially linear, comprised of substantially straight-line movement towards the work performing machinery 20 and substantially straight-line movement away from the work performing machinery 20. This relative movement occurs both during initial setup of the system and during operation of the system. In the preferred embodiment of the present invention the work performing machinery 20 is maintained in a fixed position, for example being bolted to a factory floor, while the power generating device 10 is movable. The reverse configuration is also contemplated.

The automatic belt tensioning device 100 of the present invention comprises an inflatable air spring 110 and a pressurizing device 120. See FIGS. 1 through 4. Industrial air springs 110 are well known in the art. An air spring 110 has a substantially hollow interior and a durable exterior. It is capable of receiving and containing compressible gas within its interior. It is further capable of expanding and contracting primarily along a linear dimension in response to the atmospheric pressure of the gas contained therein. Any industrial air spring 110 may be used. The pressurizing device 120 may be any device capable of delivering gas into the air spring 110 and maintaining that gas at a constant atmospheric pressure. An example of the pressurizing device 120 is an air compressor. In an alternative embodiment a plurality of air springs 110 may be used, with each air spring 110 being pressurized to the same pressure as each other air spring 110.

When properly configured, the air spring 110 is positioned between the power generating device 10 and the work performing machinery 20. See FIG. 1. It is oriented such that its direction of expansion is along the axis of relative movement between the power generating device 10 and the work performing machinery 20. The power generating device 10 and the work performing machinery 20 moreover are positioned in sufficiently close proximity to each other that the expansion of the air spring 110 is capable of moving the power generating device 10 and the work performing machinery 20 apart from each other.

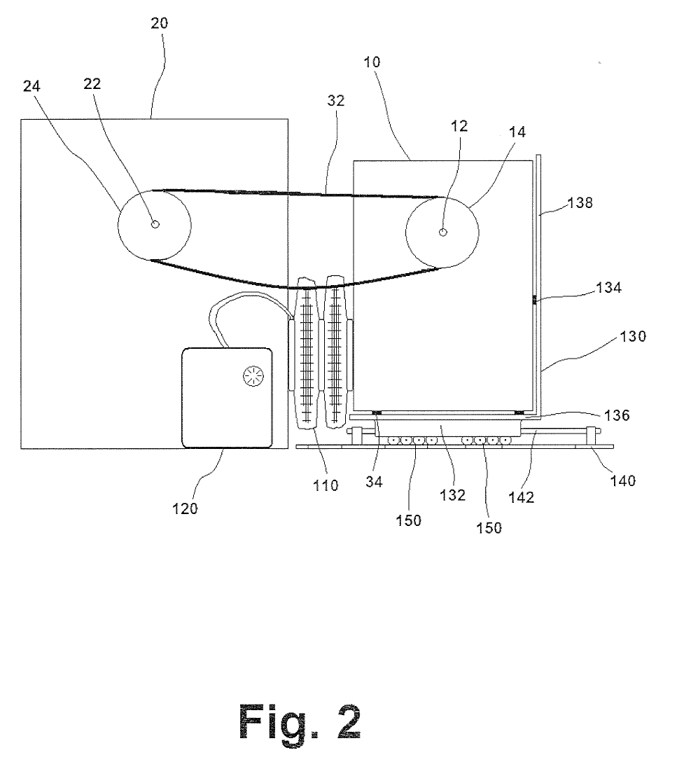

Setting up the system entails having the air spring 110 in a deflated state and the power generating device 10 and the work performing machinery 20 positioned in closer proximity to each other than required for operation. See FIG. 2. The slack belt 32 is then positioned over the sheaves 14, 24. Once the belt is properly positioned, the pressurizing device 120 is activated and the air spring 110 is inflated to the desired pressure. Inflation of the air spring 110 pushes the power generating device 10 and the work performing machinery 20 apart, thereby removing the slack from the belt 32 and appropriately tensioning the belt 32 for proper operation of the machinery 20. See FIG. 1.

When the system is in use, the pressurizing device 120 maintains a predetermined atmospheric pressure within the air spring 110, selected to match the desired tension of the one or more belts 32 mechanically linking the rotatable shafts 12,22 of the power generating device 10 and the work performing machinery 20. So, for example, if the desired tension of the one or more belts 32 is 40 pounds per square inch, the air spring 110 will be pressurized to 40 pounds per square inch. The pressurized air spring 110 will push against both the work performing machinery 20 and the power generating device 10, having a tendency to move the power generating device 10 away from the work performing machinery 20, while the resiliency of the one or more belts 32 will have a tendency to draw the power generating device 10 toward the work performing machinery 20. These two opposing forces remain in equilibrium by the constant pressure maintained by the pressurizing device 120.

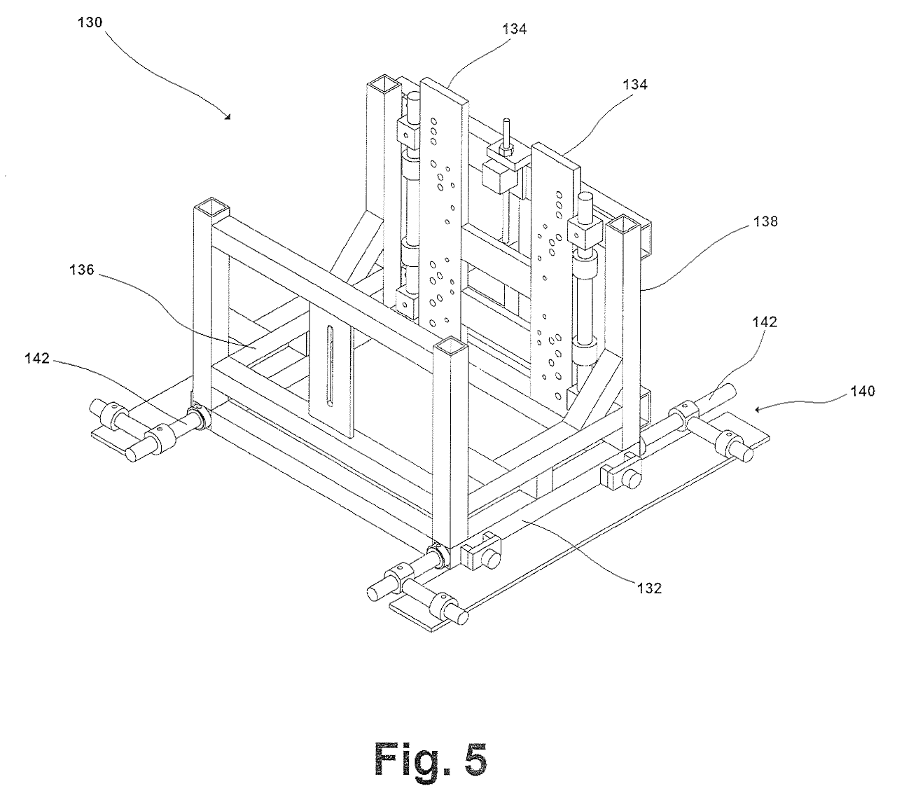

In one embodiment of the present invention, the system further comprises a movable carriage 130. See FIG. 5. The carriage 130 is capable of supporting the power generating device 10, and movement of the carriage 130 causes movement of the power generating device 10. The carriage 130 may be made of steel, angle iron, alloyed metals, or any other suitable material having the characteristics of strength, rigidity, and durability. In one embodiment the carriage 130 has a lower portion 136 and a rear portion 138. The lower portion 136 is oriented substantially horizontally and may be configured as an open square frame. Other configurations include a lattice-work frame or a solid plate. The rear portion 138 of the carriage 130 is oriented substantially vertically and may be configured similarly to the lower portion 136. The power generating device 10 is placed onto the lower portion 136 of the carriage 130 and against the rear portion 138 of the carriage 130. In the preferred embodiment the power generating device 10 is fixedly attached to the carriage 130. In one embodiment the power generating device 10 is fixedly attached to the carriage 130 by motor mounts 134. In such a configuration the power generating device 10 may be fixedly attached to the lower portion 136 of the carriage 130 by a plurality of mounts 134 and to the rear portion 138 of the carriage 130 by one or more mounts 134. The mounts 134 may be manufactured using a resilient material to dampen vibrations caused by operation of the power generating device 10. Any other configuration of mounts 134 may be used, such as brackets, fasteners, clamps, etc., provided the mounts 134 are capable of securing the power generating device 10 to the carriage 130.

The movable carriage 130 may be mounted on rolling devices 150 such as wheels, rollers, casters, or the like. Where rolling devices 150 are used with the carriage 130, the carriage 130 may be adapted to run on a track. In such configurations, the track is fixed in relation to the work performing machinery 20 and oriented such that the carriage 130, and the power generating device 10 borne thereupon, travels in a linear direction towards and away from the work performing machinery 20. Alternatively, the carriage 130 may be mounted on rails 140. Still another configuration contemplates a combination of rolling devices 150 and rails 140 to facilitate movement of the carriage 130. In yet another embodiment, the rolling devices 150 may be integrated directly with the power generating device 10, without use of a separate carriage 130. In such embodiments a fixed track may also be used to guide the movement of the power generating device 10.

In a preferred embodiment of the present invention the carriage 130 is designed to move along a rail system 140. The carriage 130 in this embodiment comprises a pair of engagement footers 132, with each footer 132 located on the underside of the carriage 130. Each footer 132 is substantially tubular and hollow and is oriented with its axis substantially parallel to the direction of travel of the carriage 130. Rollers 150 may be integrated on the underside of the footers 132. The rail system 140 is fixed in relation to the work performing machinery 20 and oriented such that the carriage 130, and the power generating device 10 borne thereupon, travels in a linear direction towards and away from the work performing machinery 20. The rail system 140 comprises a pair of elongate guide shafts 142, with each guide shaft 142 being substantially parallel to the other guide shaft 142 and oriented substantially horizontally and parallel to the direction of travel of the carriage 130. Each guide shaft 142 is substantially tubular, with an outside diameter just slightly smaller than the inside diameter of a corresponding footer 132. The footers 132 of the carriage 130 are placed onto the corresponding guide shafts 142 and slide over the guide shafts 142. The integrated rollers 150 under the footers 132 facilitate movement of the carriage 130. So configured, the carriage 130 is movably attached to the rail system 140 and capable of riding along the rail system 140, easily sliding towards and away from the work performing machinery 20. Lateral and upward movement of the carriage 130 is prevented, however, ensuring proper alignment of the power generating device 10 with the work performing machinery 20 for efficient operation of the belt-driven transmission system 30. Other configurations of a rail system 140 are also contemplated, with a corresponding configuration of the carriage 130 as needed to engage the rail system 140. The rail system 140 need only be capable of guiding the carriage 130 in its linear movements while preventing lateral or upward movement of the carriage 130. End stops may also be used on the rails 140 to limit the maximum amount of travel of the carriage 130 away from the work performing machinery 20.

In one embodiment of the present invention the air spring 110 is directly coupled to the work performing machinery 20. In another embodiment the air spring 110 is directly coupled to the power generating device 10. In either of these embodiments the direct coupling may be accomplished through any mode of fastening, such as bolts, welds, rivets, clips, pins, and the like. In yet another embodiment both the work performing machinery 20 and the power generating device 10 are directly coupled to the air spring 110. In this configuration the work performing machinery 20 and the power generating device 10 must be located sufficiently close to each other such that the distance between them does not exceed the limit of linear expansion of the air spring 110. Where a greater distance between the work performing machinery 20 and the power generating device 10 is desired, intermediate coupling devices 170 may be interposed between the air spring 110 and the work performing machinery 20 or the power generating device 10 or both. See FIG. 4. Such intermediate coupling devices 170 may be any rigid member making a connection between the air spring 110 and the work performing machinery 20 or the power generating device 10. The coupling device 170 may be a metal rod, angle iron, a bracket, a connecting shaft, scaffolding, or the like. The only required characteristics for the coupling device 170 are that it have a defined length and be substantially non-compressible, so that expansion of the air spring 110 will cause a corresponding movement of the coupling device 170.

Those skilled in the art will perceive improvements, changes and modifications in the present invention. Such improvements, changes and modifications within the skill of the art are intended to be covered by the claims set forth herein without departing from the subject or spirit of the present invention as defined in the claims, and all matter contained in the accompanying specification shall be interpreted as illustrative only and not in a limiting sense.

I claim:

1. An automatic belt tensioning device for use with a belt-driven transmission system,
said belt-driven transmission system capable of transmitting power from a power generating device to work performing machinery,
said belt-driven transmission system comprised of one or more flexible, continuous loop belts mechanically linking two or more rotatable shafts, each said shaft having one or more sheaves capable of engaging with said one or more belts, with at least one said shaft integrated with said power generating device and at least one said shaft integrated with said work performing machinery, and
said power generating device being in movable relationship with the work performing machinery;
said automatic belt tensioning device comprising
an inflatable air spring, said air spring having a substantially hollow interior and a durable exterior, said air spring being capable of receiving and containing compressible gas within its interior, said air spring further being capable of expanding and contracting along a linear dimension in response to atmospheric pressure of the gas contained therein; and
a pressurizing device, said pressurizing device capable of delivering said gas into the air spring such that said gas contained within the air spring is maintained at a constant atmospheric pressure;
whereby the air spring is interposed between the power generating device and the work performing machinery and the pressurizing device delivers said gas into the air spring and maintains the gas at a predetermined atmospheric pressure, said predetermined atmospheric pressure selected to offset the desired tension of the one or more belts mechanically linking the rotatable shafts of the power generating device and the work performing machinery,
with expansion of the air spring along its linear dimension capable of moving the power generating device and the work performing machinery apart relative to each other.

2. The automatic belt tensioning device of claim 1 wherein the work performing machinery is maintained in a fixed position and the power generating device is movable.

3. The automatic belt tensioning device of claim 2 further comprising
a carriage, the power generating device being fixedly attached to said carriage and said carriage being capable of supporting the power generating device; and
a rail system, said rail system being maintained in a fixed position;
wherein the carriage is movably attached to the rail system and capable of riding along the rail system such that the power generating device is movable in a linear direction towards the work performing machinery and in an opposite linear direction away from the work performing machinery.

4. The automatic belt tensioning device of claim 3 wherein
the rail system comprises a pair of guide shafts, each guide shaft being substantially tubular and elongate and having an outside diameter, each guide shaft oriented substantially horizontally and substantially parallel to the other guide shaft and along the linear dimension of movement of the carriage; and
the carriage comprises a pair of engagement footers, each footer being substantially tubular and having an inside diameter slightly larger than the outside diameter of the corresponding guide shaft, each footer adapted to slide over the corresponding guide shaft, and each footer further fitted with rollers on its underside such that the carriage is capable of rolling on the rollers;
whereby movement of the carriage is constrained in its linear dimension by movement of the engagement footers along the guide shafts.

5. The automatic belt tensioning device of claim 3 wherein the power generating device is fixedly attached to the carriage by a plurality of mounts.

6. The automatic belt tensioning device of claim 5 wherein
the carriage comprises a lower portion and a rear portion, with the lower portion oriented substantially horizontally and the rear portion oriented substantially vertically;
whereby the footers are integrated with the lower portion of the carriage,
the power generating device rests on the lower portion of the carriage and against the rear portion of the carriage, and
the power generating device is fixedly attached to the lower portion of the carriage by a plurality of mounts and the power generating device is fixedly attached to the rear portion of the carriage by one or more mounts.

7. The automatic belt tensioning device of claim 2 wherein the power generating device comprises a plurality of wheels such that the power generating device is movable towards the work performing machinery and away from the work performing machinery.

8. The automatic belt tensioning device of claim 7 further comprising a track, said track being maintained in a fixed position, wherein the wheels of the power generating device are capable of riding along the track such that the power generating device is movable in a linear direction towards the work performing machinery and in an opposite linear direction away from the work performing machinery.

9. The automatic belt tensioning device of claim 8 further comprising a carriage, the power generating device being fixedly attached to said carriage by a plurality of mounts and said carriage being capable of supporting the power generating device, whereby the plurality of wheels are attached to the carriage.

10. The automatic belt tensioning device of claim 1 wherein the air spring is directly coupled to the work performing machinery.

11. The automatic belt tensioning device of claim 1 wherein the air spring is directly coupled to the power generating device.

12. The automatic belt tensioning device of claim 1 wherein the air spring is indirectly coupled to the work performing machinery via a coupling device.

13. The automatic belt tensioning device of claim 1 wherein the air spring is indirectly coupled to the power generating device via a coupling device.

14. The automatic belt tensioning device of claim 1 wherein the air spring is indirectly coupled to the work performing machinery via a first coupling device and the air spring is indirectly coupled to the power generating device via a second coupling device.

15. The automatic belt tensioning device of claim 1 wherein the power generating device is an electric motor.

16. The automatic belt tensioning device of claim 1 wherein the pressurizing device is an air compressor.
